(19) United States
(12) Patent Application Publication
(10) Pub. No.: US 2005/0157188 A1
(43) Pub. Date: Jul. 21, 2005

(54) Image capturing apparatus and method of performing noise process on moving picture

(75) Inventor: Hiroaki Kubo, Muko-shi (JP)

Correspondence Address: SIDLEY AUSTIN BROWN & WOOD LLP, 717 NORTH HARWOOD, SUITE 3400, DALLAS, TX, 75201, US

(73) Assignee: KONICA MINOLTA PHOTO IMAGING, INC.

(21) Appl. No.: 10/828,028

(22) Filed: Apr. 19, 2004

(30) Foreign Application Priority Data
Jan. 20, 2004 (JP) JP2004-012162

(51) Int. Cl. H04N 5/217

(52) U.S. Cl. 348/241

(57) ABSTRACT

The image capturing apparatus can remove noise by a circulating filter process in capture of a moving picture and also by multiframe exposure. In the case where an AGC gain is higher than a threshold Ref1, that is, at the time of low illuminance, whether the focal length of a taking lens is set to the tele-side or not is determined. If the focal length is set to the tele-side on which a camera-shake often occurs, noise is removed by the circulating filter process which is relatively resistive to a camera-shake. On the other hand, if the focal length is not set to the tele-side, noise is removed by the multiframe exposure by which a relatively high-quality image can be captured. As a result, since switching is made between the circulating filter process and the multiframe exposure in accordance with situations, the proper noise removing process can be performed in capture of a moving picture at the time of low illuminance.

This application is based on application No. 2004-012162 filed in Japan, the contents of which are hereby incorporated by reference.

### BACKGROUND OF THE INVENTION

1. Field of the Invention

The present invention relates to a technique of an image capturing apparatus for capturing an image of a subject and sequentially generating frames constructing a moving picture.

2. Description of the Background Art

In capture of a moving picture by a digital camera (image capturing apparatus), sensitivity tends to be insufficient with increase in the number of pixels, and increase in noise at the time of low illuminance is unavoidable.

As a technique of improving capture of a moving picture at the time of low illuminance, a technique of removing noise by lowering a frame rate is disclosed in, for example, Japanese Patent Application Laid-Open No. 2003-87633.

A technique of removing noise on the basis of correlation between frames by using a circulating filter (feedback filter) is disclosed in, for example, Japanese Patent Application Laid-Open No. 6-38098 (1994). The technique will be briefly described with reference to FIG. 12 expressing the concept of the feedback filter process.

FIG. 12 is a block diagram for describing the circulating filter process according to a conventional technique.

Image data (Bayer data) generated by an image capturing device is subjected to pixel interpolation by a pixel interpolator 81, the color space of the pixel-interpolated image data is converted by a color difference matrix 82, and the resultant data is inputted to two circulating filters 83. By a feedback filter process in the circulating filters 83, noise in capture a moving picture is removed.

In the technique of Japanese Patent Application Laid-Open No. 2003-87633, the frame rate is lowered in capture of a moving picture at the time of low illuminance. Consequently, blurring of an image of one frame increases and followability of an image deteriorates. When the movement of a subject is fast, it is difficult to obtain a smooth moving picture.

In the technique of Japanese Patent Application Laid-Open No. 6-38098 (1994), the circulating filter process is performed in capture of a moving picture at the time of low illuminance. Although predetermined noise reduction can be achieved with a small feedback amount, the quality of a captured moving picture is lower than that of the technique of Japanese Patent Application Laid-Open No. 2003-87633.

### SUMMARY OF THE INVENTION

The present invention is directed to an image capturing apparatus.

According to the present invention, an image capturing apparatus includes: an image generator for capturing an image of a subject and sequentially generating frame images of the subject; a first noise reducer for performing a first noise process using a feedback factor on the frame images sequentially generated by the image generator; a second noise reducer for performing a second noise process by lowering frame rate at the time of generating the frame images by the image generator; and a selector for selecting either the first noise reducer or the second noise reducer when a predetermined image capturing condition is satisfied. Therefore, a proper noise process can be performed in capture of a moving picture.

In a preferred embodiment of the present invention, the image capturing apparatus further includes a manual operation member to be operated by a user. The selector selects either the first noise reducer or the second noise reducer in accordance with an operation input of the manual operation member. Therefore, noise removal intended by the user can be performed.

The present invention is also directed to a method of performing a noise process on a moving picture.

Therefore, an object of the present invention is to provide a technique of an image capturing apparatus in which a proper noise process can be performed in capture of a moving picture.

These and other objects, features, aspects and advantages of the present invention will become more apparent from the following detailed description of the present invention when taken in conjunction with the accompanying drawings.

### BRIEF DESCRIPTION OF THE DRAWINGS

FIGS. 1A to 1C are diagrams showing a configuration of main components of an image capturing apparatus according to a first preferred embodiment of the present invention;

FIG. 2 is a diagram showing functional blocks of the image capturing apparatus;

FIG. 3 is a diagram for describing a circulating filter process in the image capturing apparatus;

FIG. 4 is a flowchart showing the operation of the circulating filter process in the image capturing apparatus;

FIG. 5 is a flowchart showing a basic operation of the image capturing apparatus;

FIG. 6 is a flowchart showing another operation of the image capturing apparatus;

FIG. 7 is a flowchart showing a basic operation of an image capturing apparatus according to a second preferred embodiment of the present invention;

FIG. 8 is a flowchart showing a basic operation of an image capturing apparatus according to a third preferred embodiment of the present invention;

FIG. 9 is a flowchart showing an operation of a circulating filter process in an image capturing apparatus according to a fourth preferred embodiment of the present invention;

FIG. 10 is a flowchart showing an operation of a circulating filter process in an image capturing apparatus according to a fifth preferred embodiment of the present invention;

FIG. 11 is a flowchart showing an operation of a circulating filter process in an image capturing apparatus according to a sixth preferred embodiment of the present invention; and

FIG. 12 is a block diagram for describing a circulating filter process according to a conventional technique.

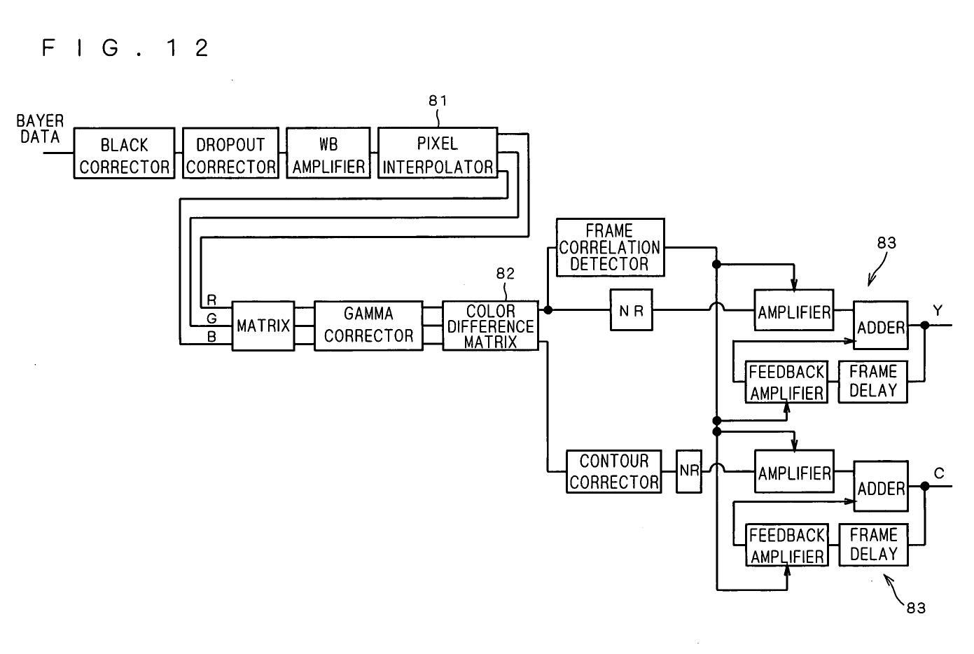

### DESCRIPTION OF THE PREFERRED EMBODIMENTS

### First Preferred Embodiment

Configuration of Main Components of Image Capturing Apparatus

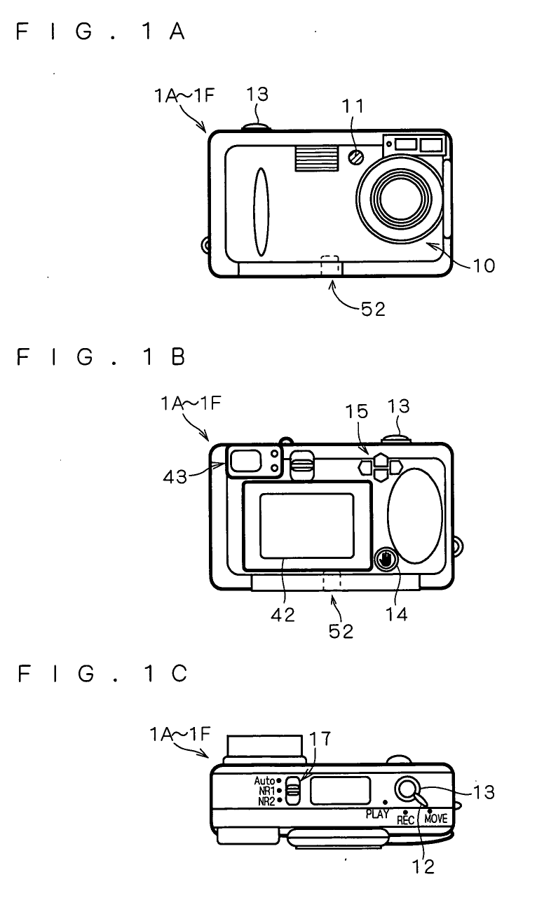

FIGS. 1A to 1C are diagrams showing a configuration of main components of an image capturing apparatus 1A according to a first preferred embodiment of the present invention. FIGS. 1A 1B, and 1C are a front view, a rear view and a top view, respectively, of the image capturing apparatus 1A.

The image capturing apparatus 1A is constructed as a digital camera and has a taking lens 10. In the front face of the image capturing apparatus 1A, a photometric sensor 11 for performing photometric measurement on a subject and generating a luminance signal is provided.

The image capturing apparatus 1A has, on its top surface, a mode changing switch 12, a shutter start button 13 and an NR (Noise Reduction) mode selecting switch 17.

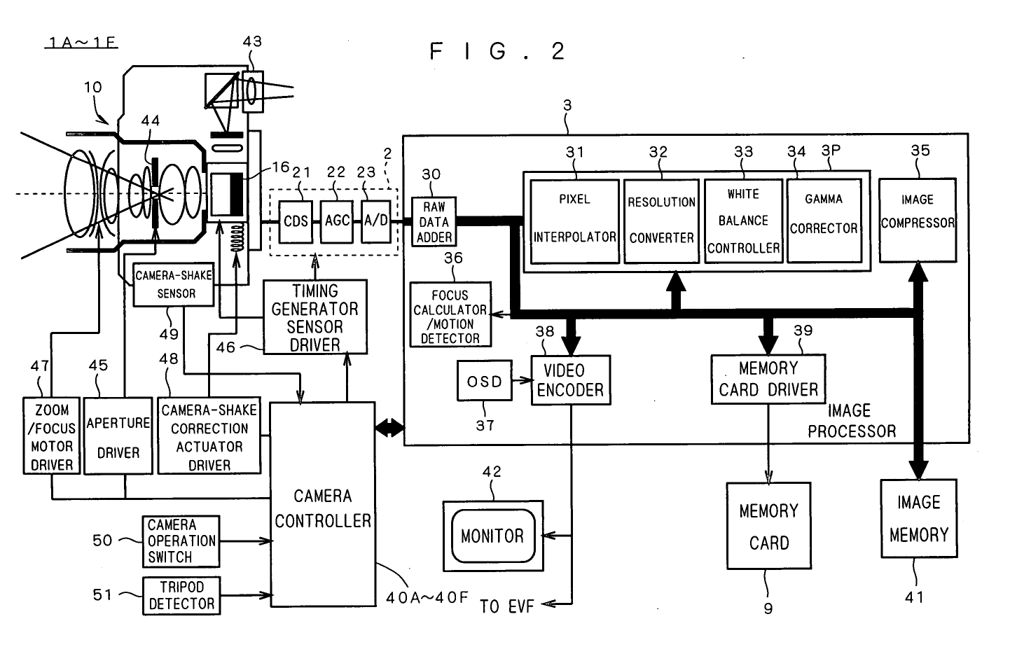

The mode changing switch 12 is a switch for changing the mode among a still picture capturing mode (REC mode) for capturing an image of a subject and recording a still picture of the subject, a moving picture mode (MOVE mode) for capturing a moving picture, and a playback mode (PLAY mode) for playing back the picture recorded on a memory card 9 (see FIG. 2).

The shutter start button 13 is a two-level switch capable of detecting a half-pressed state (S1 on) and a depressed state (S2 on). When the shutter start button 13 is pressed halfway in the still picture capturing mode, a zoom focus motor driver 47 (see FIG. 2) is driven and an operation of moving the taking lens 10 to a focus position is performed. On the other hand, when the shutter start button 13 is depressed all the way in the still picture capturing mode, an image capturing operation for recording is performed.

The NR mode selecting switch 17 is a switch for switching the process among a noise reducing process “NR1” using a circulating filter process (which will be described later) in capture of a moving picture at the time of low illuminance, a noise reducing process “NR2” performed by multiframe exposure (which will be described later) and a process “Auto” of automatically selecting one of the two kinds of noise processes NR1 and NR2 in accordance with situations.

On the rear face of the image capturing apparatus 1A, an LCD (Liquid Crystal Display) monitor 42 for displaying a captured image or the like, an electronic view finder (EVF) 43, a camera-shake correction switch 14 and a frame-advance/zoom switch 15 are provided.

The camera-shake correction switch 14 is a switch for setting a camera-shake correction mode of making a camera-shake correction by driving a camera-shake correction actuator driver 48 (FIG. 2) so that an adverse influence of a camera-shake detected by a camera-shake sensor 49 (FIG. 2) is not exerted onto the image capturing operation. An image capturing sensor 16 can move, for example, two dimensionally in directions orthogonal to the optical axis of the taking lens 10 by two actuators which perform linear driving.

The frame-advance/zoom switch 15 is a switch constructed by four buttons and for instructing advancing of frames of a recorded image in a playback mode and zooming at the time of image capturing. By the operation of the frame-advance/zoom switch 15, the zoom focus motor driver 47 is driven and a focal length of the taking lens 10 can be changed.

FIG. 2 is a diagram showing functional blocks of the image capturing apparatus 1A.

The image capturing apparatus 1A has the image capturing sensor 16, a signal processor 2 connected to the image capturing sensor 16 so as to be able to send data, an image processor 3 connected to the signal processor 2, and a camera controller 40A connected to the image processor 3.

The image capturing sensor 16 is constructed as an area sensor (image capturing device) in which primary-color transmission filters of R (red), G (green) and B (blue) are arranged in checkers on a pixel unit basis (Bayer matrix) and is of an all-pixel-reading type. The image capturing sensor 16 sequentially generating frames constructing a moving picture as RAW image data (Bayer data).

The signal processor 2 has a CDS 21, an AGC 22 and an A/D converter 23.

An analog image signal obtained and outputted by the image capturing sensor 16 is sampled by the CDS 21 and subjected to noise reduction. After that, the resultant signal is multiplied by an analog gain corresponding to image capturing sensitivity by the AGC 22, thereby correcting sensitivity.

The A/D converter 23 is constructed as a 14-bit converter and converts an analog signal normalized by the AGC 22 into a digital signal. The digital image signal is subjected to predetermined image processes in the image processor 3 and an image file is thereby generated.

The image processor 3 has a RAW data adder 30, a digital processor 3p and an image compressor 35. The image processor 3 also has a focus calculator/motion detector 36, an OSD (On Screen Display) 37, a video encoder 38 and a memory card driver 39.

The digital processor 3p has a pixel interpolator 31, a resolution converter 32, a white balance controller 33 and a gamma corrector 34.

Image data inputted to the image processor 3 is written into the image memory 41 synchronously with reading of the image capturing sensor 16. After that, the image data stored in the image memory 41 is accessed and various processes are performed on the image data in the image processor 3.

Each of RGB pixels of the image data in the image memory 41 is independently subjected to gain correction by the white balance controller 33, and white balance correction of RGB is performed. In the white balance correction, a part which is inherently white is estimated from an image capturing subject on the basis of luminance, saturation data and the like, an average value of each of R, G and B of the portion, a G/R ratio and G/B ratio are obtained. On the basis of the information, the data is controlled as correction gains of R and B.

Each of the R, G and B pixels of the image data subjected to the white balance correction is masked with a filter pattern in the pixel interpolator 31. Each of the G pixels having pixel values also in a high frequency band is replaced with an average value of intermediate two values of surrounding four pixels by a median (median value) filter. Each of the R and B pixels is interpolated by averaging the brightness of surrounding nine pixels of the same color and placing pixels of that brightness among the pixels.

The pixel-interpolated image data is subjected to nonlinear conversion, specifically, gamma correction and offset adjustment, adapted to each output device by the gamma corrector 34, and the resultant data is stored into the image memory 41.

The number of pixels of the image data stored in the image memory 41 is reduced to the number of pixels set by the resolution converter 32 in the horizontal and vertical directions. The resultant data is compressed by the image compressor 35 and, after that, the compressed data is recorded in the memory card 9 which is set in the memory card driver 39. At the time of recording an image, a captured image of designated resolution is recorded and a screen nail image (VGA) for playback display is generated and recorded in link with the captured image. At the time of playing back an image, the screen nail image is displayed on the LCD monitor 42. In such a manner, an image can be displayed at high speed.

The resolution converter 32 reduces the number of pixels every predetermined number of pixels also at the time of displaying an image, thereby generating a low-resolution image to be displayed on the LCD monitor 42 and the EVF 43. At the time of preview, a low-resolution image of 640×240 pixels read from the image memory 41 is encoded by the video encoder 38 to an image of the NTSC or PAL system. By using the encoded data as a field image, an image is played back on the LCD monitor 42 and EVF 43.

The focus calculator/motion detector 36 extracts frequency components of a focus region by dividing an image into a plurality of blocks and performing a BPF process on the block unit basis, and compares the frequency components on a frame unit basis, and a focus lens is driven. After such so-called video AF is performed and focus is achieved, the movement of the subject is detected on the basis of a displacement amount of an evaluation value in each block, and the AF control is executed again.

When a focus target moves in the AF operation, the AF evaluation value becomes a low value. When a focus target enters a predetermined focus state, a high AF evaluation value is outputted. By using the AF evaluation value of such a characteristic, the movement of the subject can be detected.

The OSD 37 generates various characters, symbols, frames and the like and can superimpose generated data in an arbitrary position of a displayed image. By the OSD 37, various characters, symbols, frames and the like can be displayed as necessary on the LCD monitor 42.

The camera controller 40A is a part having a CPU and a memory and for controlling parts of the image capturing apparatus 1A in a centralized manner. Concretely, the camera controller 40A processes an operation input of the user performed on a camera operation switch 50 including the mode changing switch 12 and the shutter start button 13. The camera controller 40A switches the mode among the still picture capturing mode for capturing an image of a subject and recording the image data, the moving picture mode and the playback mode in accordance with an operation on the mode changing switch 12 by the user.

A tripod detector 51 is a part for detecting attachment of a tripod to a tripod hole 52 (shown by broken lines in FIGS. 1A and 1B) formed in the under surface of the image capturing apparatus 1A.

In the image capturing apparatus 1A, at the time of preview display (live view display) for displaying a subject in a moving picture mode on the LCD monitor 42 in an image capture preparing state before image capture, an open state of an optical aperture of an aperture 44 is fixed by an aperture driver 45. With respect to charge accumulation time (exposure time) of the image capturing sensor 16 corresponding to shutter speed (SS), the camera controller 40A computes exposure control data on the basis of a live view image obtained by the image capturing sensor 16. By referring to a program chart which is preset on the basis of the calculated exposure control data, a feedback control on a timing generator sensor driver 46 is performed so that the exposure time of the image capturing sensor 16 becomes proper.

After completion of the charge accumulation in the image capturing sensor 16, a photoelectrically converted signal is shifted to a transfer path in the image capturing sensor 16 which is light shielded, and the signal is read from the transfer path via a buffer.

In the image capturing apparatus 1A having such a configuration, two kinds of noise removing processes can be performed in capture of a moving picture at the time of low illuminance. The noise processes will be described in detail below.

Circulating Filter Process (NR1)

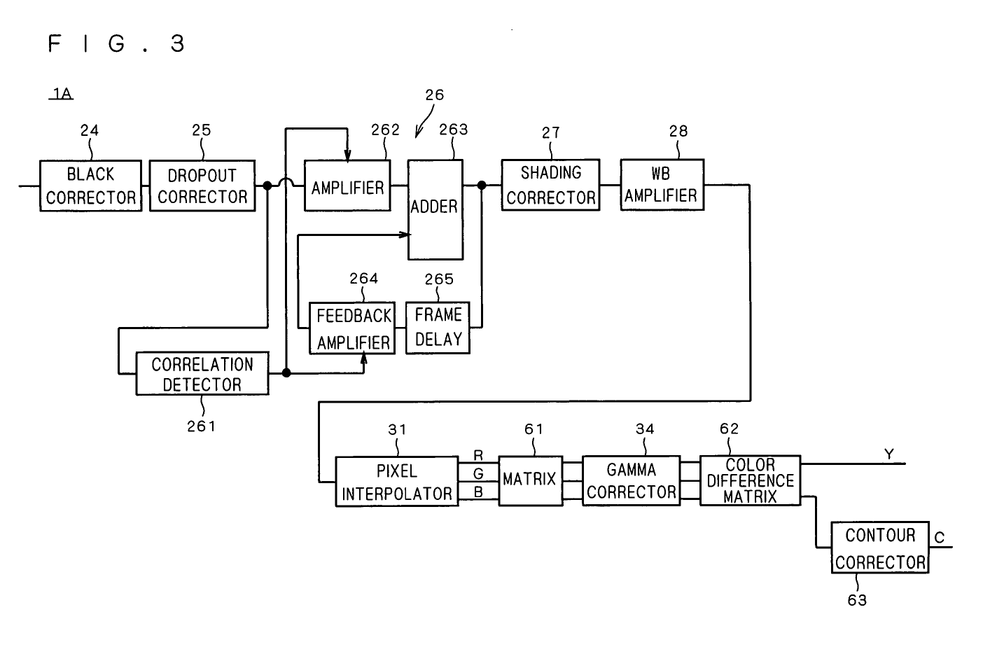

FIG. 3 is a diagram for describing a circulating filter process in the image capturing apparatus 1A.

In the image capturing apparatus 1A, the image processor 3 has a black corrector 24, a dropout corrector 25, a circulating filter 26, a shading corrector 27 and a white balance (WB) amplifier 28. In each of the parts, an image process is performed on RAW image data of a digital signal generated by the image capturing sensor 16 and outputted from the signal processor 2. The RAW image data is image data which is outputted from the image capturing sensor 16 and has not yet been subjected to pixel interpolation.

The image processor 3 has not only the pixel interpolator 31 and the gamma corrector 34 shown in FIG. 2 but also a matrix 61 for making color correction or the like by using, for example, a 3×3 matrix, a color difference matrix 62 and a contour corrector 63.

The black corrector 24 is a part for performing black level correction on the RAW image data of a frame generated by the image capturing sensor 16.

The dropout corrector 25 is a part for correcting a pixel dropout in the case where a dropout, that is, a pixel dropout exists in the RAW image data of the frame generated by the image capturing sensor 16.

The circulating filter 26 has a correlation detector 261, an amplifier 262, an adder 263, a feedback amplifier 264 and a frame delay 265.

In the circulating filter 26, the adder 263 adds a signal obtained by multiplying an image of an immediately preceding frame outputted from the frame delay 265 having a frame memory and holding image data with a gain factor (feedback factor) by the feedback amplifier 264 and a signal obtained by multiplying an image of the present frame with a gain factor set by the amplifier 262. That is, in the circulating filter 26, a noise process for multiplying the difference between the RAW image data of the present frame generated by the image capturing sensor 16 and the RAW image data of the immediately preceding frame with the feedback factor and subtracting the resultant from the RAW image data of the present frame is performed.

The feedback factor of the feedback amplifier 264 is determined in accordance with correlation between an image of the present frame and an image of the immediately preceding frame. Concretely, when the correlation between the frames is high, a high feedback factor of the feedback amplifier 264 is set to increase a feedback amount, and noise which is not related to the correlation is suppressed. On the other hand, if the feedback factor is increased when the correlation between the frames is low, blurring occurs in an image. Consequently, when the correlation between frames is low, the feedback factor is decreased to reduce a feedback amount, and degradation of the image is minimized.

In the control of the feedback factor, correlation between frames is calculated on the basis of an AF evaluation value in the correction detector 261, and a feedback factor according to the correlation is set.

The shading corrector 27 is a part for correcting a difference between a light amount in a center portion and a light amount in a peripheral portion caused by the taking lens 10, that is, darkness of the peripheral portion in RAW image data of the frame subjected by the filter process of the circulating filter 26. In the shading corrector 27, a process of performing amplification at different amplification factors in the parts of the image is performed.

The WB amplifier 28 is a part corresponding to the white balance controller 33 and performs a white balance correction of RGB on the RAW image data of the frame subjected to the filter process in the circulating filter 26.

The RAW image data of the frame subjected to the white balance correction in the WB amplifier 28 is subjected to pixel interpolation by the pixel interpolator 31, and the matrix calculation is executed by the matrix 61. The image data is subjected to the gamma correction in the gamma corrector 34 and converted into a luminance signal (Y) and a color difference signal (C) in the color difference matrix 62 and, after that, contour correction is made by the contour corrector 63.

In the image capturing apparatus 1A, the noise removing process NR1 is performed by the circulating filter 26 in capture of a moving picture at the time of low illuminance.

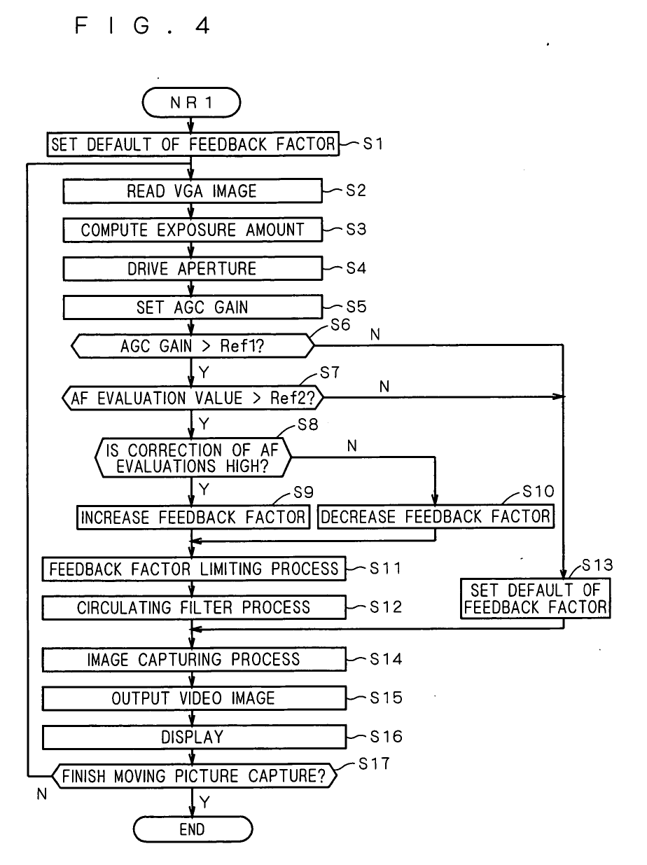

FIG. 4 is a flowchart showing the operation of the circulating filter process in the image capturing apparatus 1A. The operation is executed by the camera controller 40A.

In step S1, the feedback factor is set to a default value (for example, 0.2). That is, the gain factor in the feedback amplifier 264 in the circulating filter 26 is set to an initial value.

In step S2, a VGA image is read as a moving picture. That is, a frame image is read from the image capturing sensor 16.

In step S3, an exposure amount is calculated on the basis of the image data read in step S2, and optimum shutter speed, an aperture value (Fno), and an AGC gain of the AGC 22 are calculated.

In step S4, an optical aperture of the aperture 44 is driven by the aperture driver 45 on the basis of the aperture value calculated in step S3.

In step S5, a gain factor of the AGC 22 is set on the basis of the AGC gain calculated in step S3.

In step S6, whether the gain set in the AGC 22 is larger than a predetermined value Ref1 or not is determined. When an AGC gain corresponding to sensitivity of image capturing is larger than the predetermined value Ref1, low illuminance is determined and the program advances to step S7. When the set gain is equal to or less than the predetermined value Ref1, the program advances to step S13.

In step S7, whether the AF evaluation value calculated by the focus calculator/motion detector 36 is larger than a predetermined value Ref2 or not is determined. In the case where the AF evaluation value is equal to or more than a predetermined value, as described above, it can be determined to a certain degree that the subject is stationary. Consequently, in this case, the filter process in the circulating filter 26 is positively performed. When the AF evaluation value is larger than the predetermined value Ref2, the program advances to step S8. When the AF evaluation value is equal to or less than the predetermined value Ref2, the program advances to step S13.

In step S8, whether the degree of correlation between frames based on the AF evaluation value is high or not is determined. If the degree of correction is high, the program advances to step S9. If the degree of correlation is low, the program advances to step S10.

In step S9, the feedback factor of the feedback amplifier 264 is increased. In this case, for example, 0.1 is added to the feedback factor.

In step S10, the feedback factor of the feedback amplifier 264 is decreased. In this case, for example, 0.1 is subtracted from the feedback factor.

In step S11, a feedback factor limiting process is performed. Specifically, when the feedback factor is larger than an upper limit value (for example, 0.8), the feedback factor is limited to the upper limit value. When the feedback factor is smaller than a lower limit value (for example, 0), the feedback factor is limited to the lower limit value. By the process, excessive feedback is suppressed, and proper noise reduction can be carried out.

In step S12, the circulating filter process is performed by the circulating filter 26.

In step S13, the feedback factor of the feedback amplifier 264 is set to a default value (for example, 0.2).

In step S14, an image capturing process is performed on image data of a frame by the image processor 3.

In step S15, a video image (moving picture) is outputted.

In step S16, the video image outputted in step S15 is displayed on a display such as the LCD monitor 42.

In step S17, whether moving picture capture has been finished or not is determined. Concretely, whether the shutter start button 13 for finishing the moving picture capture has been operated by the user or not is determined. In the case where the moving picture capture is not finished, the program returns to step S2 and the moving picture capture is continued.

Multiframe Exposure (NR2)

In the image capturing apparatus 1A, as the noise process NR2 in the moving picture capture at the time of low illumination, multiframe exposure can be performed.

In the multiframe exposure, the noise process of lowering the frame rate of moving picture capture by the control of the timing generator sensor driver 46 to thereby increase exposure time of the image capturing sensor 16 is performed. Since sensitivity at the time of image capturing can be suppressed to predetermined sensitivity, that is, the amplification gain of the AGC 22 in the signal processor 2 can be made low, noise reduction can be achieved. In the multiframe exposure, at the time of low illuminance, a large exposure amount of the image capturing sensor 16 has to be assured to make exposure proper. Consequently, for example, in an open state of the aperture 44, the charge accumulation time of the image capturing sensor 16 is set to time for a plurality of frames (multiframe exposure).

The operation of the image capturing apparatus 1A capable of performing the two kinds of noise processes NR1 and NR2 will be described below.

Operation of Image Capturing Apparatus 1A

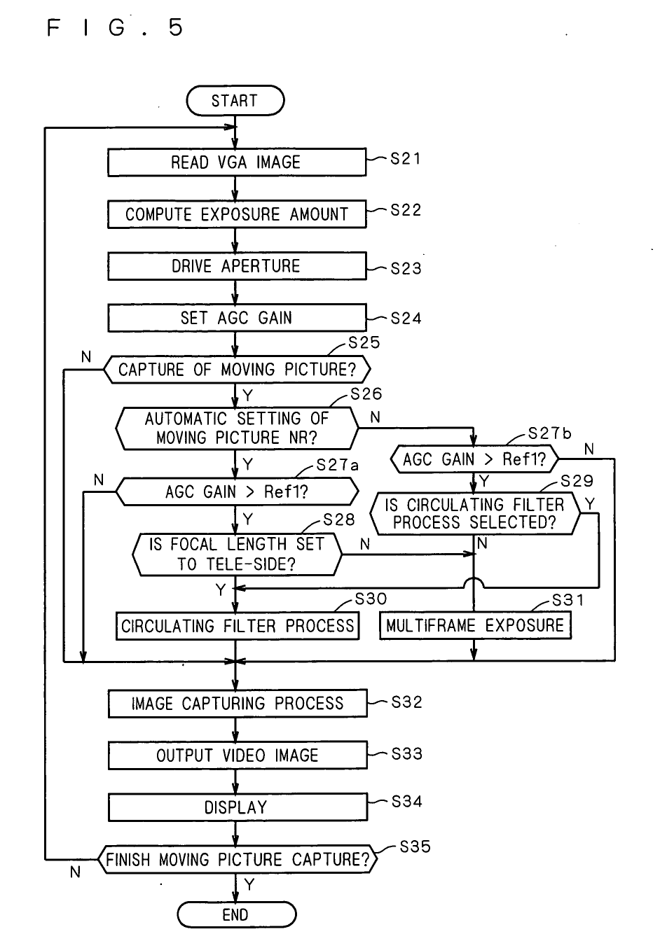

FIG. 5 is a flowchart showing a basic operation of the image capturing apparatus 1A. The operation is executed by the camera controller 40A.

In steps S21 to S24, operations similar to those in steps S2 to S5 shown in the flowchart of FIG. 4 are performed.

In step S25, whether moving picture capture is set or not is determined. Concretely, whether the mode changing switch 12 is set in the moving picture mode or not is determined. If the moving picture capture is set, the program advances to step S26. If the moving picture capture is not set, the program advances to step S32.

In step S26, whether a moving picture NR is automatically set or not is determined. Specifically, whether the NR mode selecting switch 17 is set in “Auto” or not is determined. If the automatic setting is made for the moving picture NR, the program advances to step S27a. If the automatic setting is not made, the program advances to step S27b.

In step S27a, whether the set gain in the AGC 22 is larger than a predetermined threshold Ref1 or not is determined. If the AGC gain corresponding to sensitivity of image capturing is larger than the predetermined threshold Ref1, low illuminance is determined and the program advances to step S28. If the AGC gain is equal to or less than the predetermined value Ref1, the program advances to step S32.

In step S27b, in a manner similar to step S27a, whether the set gain in the AGC 22 is larger than the predetermined threshold Ref1 or not is determined. If the AGC gain is larger than the predetermined value Ref1, the program advances to step S29. If the AGC gain is equal to or less than the predetermined value Ref1, the program advances to step S32.

In the case where the low illumination image capturing condition such that the AGC gain is larger than the predetermined value Ref1 is satisfied, from the operations in steps S27a and S27b, either the circulating filter process performed in step S30 or the multiframe exposure performed in step S31 can be selected.

In step S28, whether a focal length of the taking lens 10 is set to the tele-side or not is determined. The setting of the tele-side denotes setting of the taking lens 10 to 85 mm or longer, preferably, 100 mm or longer in 135 mm conversion.

In the case of the circulating filter process, a blur amount (shake amount) of an image can be controlled according to the feedback factor, so that the process is easily performed also on the tele-side on which a camera-shake often occurs. On the other hand, in the case of performing the multiframe exposure on the tele-side, exposure time of each frame becomes long, a blur of an image easily occurs, and the frame rate becomes lower, so that turbulence of an image due to the blur becomes conspicuous.

On the contrary, in the case of a wide view angle which is not the tele-side, a blur of a subject does not easily occur. Consequently, the quality of each frame at the time of the multiframe exposure which degrades effective sensitivity is higher, and the picture quality can be improved.

For the reasons as described above, in step S28, whether the tele-side is set or not is determined.

When the focal length on the tele-side is set in step S28, the program advances to step S30. When the focal length on the tele-side is not set, the program advances to step S31.

By the operation, either the circulating filter process or the multiframe exposure is selected according to the focal length, and the noise process is switched.

In step S29, whether the circulating filter process is manually selected as the noise process at the time of capturing a moving picture or not is determined. Specifically, whether the NR mode selecting switch 17 is set to “NR1” or not is determined. In the case where the circulating filter process is selected, the program advances to step S30. In the case where not the circulating filter process but the multiframe exposure is selected, the program advances to step S31.

In step S29, either the circulating filter process or the multiframe exposure is selected in accordance with an operation input on the NR mode selecting switch 17. In such a manner, the noise process intended by the user can be performed.

In step S30, the circulating filter process is performed.

In step S31, the multiframe exposure is performed.

In steps S32 to S35, operations similar to those of steps S14 to S17 shown in the flowchart of FIG. 4 are performed.

In the image capturing apparatus 1A as described above, either the circulating filter process or the multiframe exposure is selected according to the presence or absence of tele-side setting, that is, the focal length of the taking lens 10. Consequently, an optimum noise reducing process can be performed while preventing occurrence of a disturbance of an image or the like.

In step S28, it is not indispensable to make a switch between the circulating filter process (step S30) and the multiframe exposure (step S31) on the strict border of the threshold focal length. The switching may be performed with a hysteresis. For example, even when the focal length exceeding 85 mm gradually decreases to 85 mm or less as the focal length of the threshold value, the noise control of maintaining the state of the circulating filter process may be executed up to, for example, 70 mm. Consequently, even when the focal length fluctuates around the threshold focal length as a center, the switching between the circulating filter process and the multiframe exposure does not frequently occur, and a smooth noise reducing process can be performed.

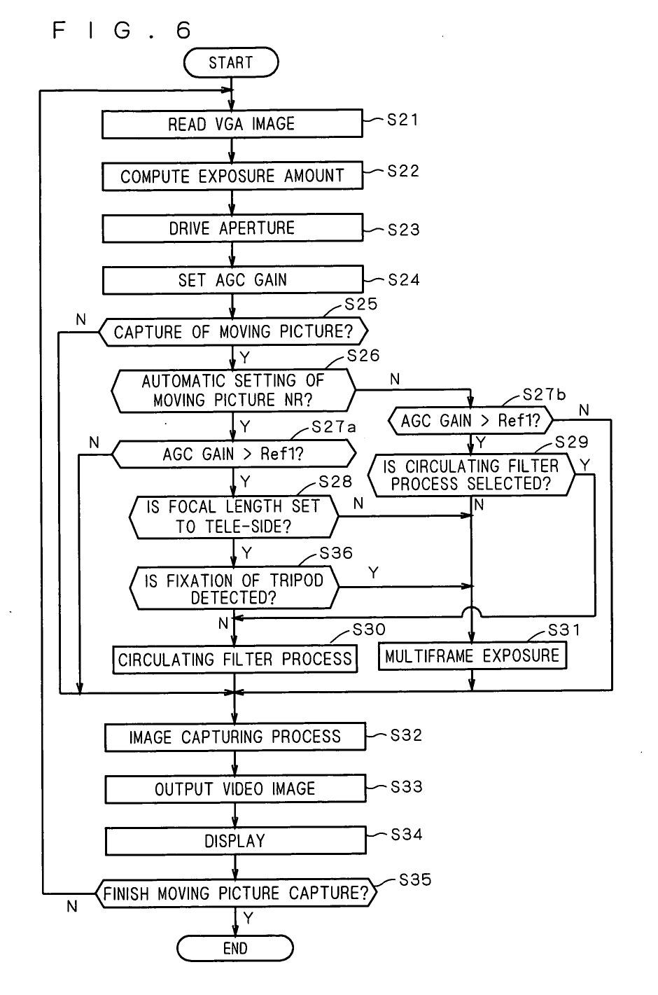

The image capturing apparatus 1A of the first preferred embodiment may perform the operation shown in the flowchart of FIG. 6 which will be described below.

The flowchart shown in FIG. 6 is different from the flowchart shown in FIG. 5 with respect to the point that the operation of step S36 is added.

In step S36, whether fixing of a tripod is detected or not is determined. Concretely, whether the tripod detector 51 detects attachment of a tripod to the tripod hole 52 or not is determined. In the case where fixation of a tripod is detected, the program advances to step S31 where the multiframe exposure is performed. On the other hand, when fixation of the tripod is not detected, the program advances to step S30 where the circulating filter process is performed.

By the operation, either the circulating filter process or the multiframe exposure is selected according to the presence or absence of connection of the tripod.

By determining the presence or absence of attachment of the tripod as described above, if fixation of the tripod is detected even when the tele-side is set, the factor of a camera-shake is eliminated, so that proper noise reduction can be carried out by the multiframe exposure.

### Second Preferred Embodiment

An image capturing apparatus 1B according to a second preferred embodiment of the present invention has a configuration similar to that of the image capturing apparatus 1A of the first preferred embodiment except for the camera controller as shown in FIGS. 1 and 2.

In a camera controller 40B of the image capturing apparatus 1B, a program for performing the operation of switching between the circulating filter process and the multiframe exposure described in the first preferred embodiment in accordance with movement of a subject is stored in a memory. The operation will be described below.

Operation of Image Capturing Apparatus 1B

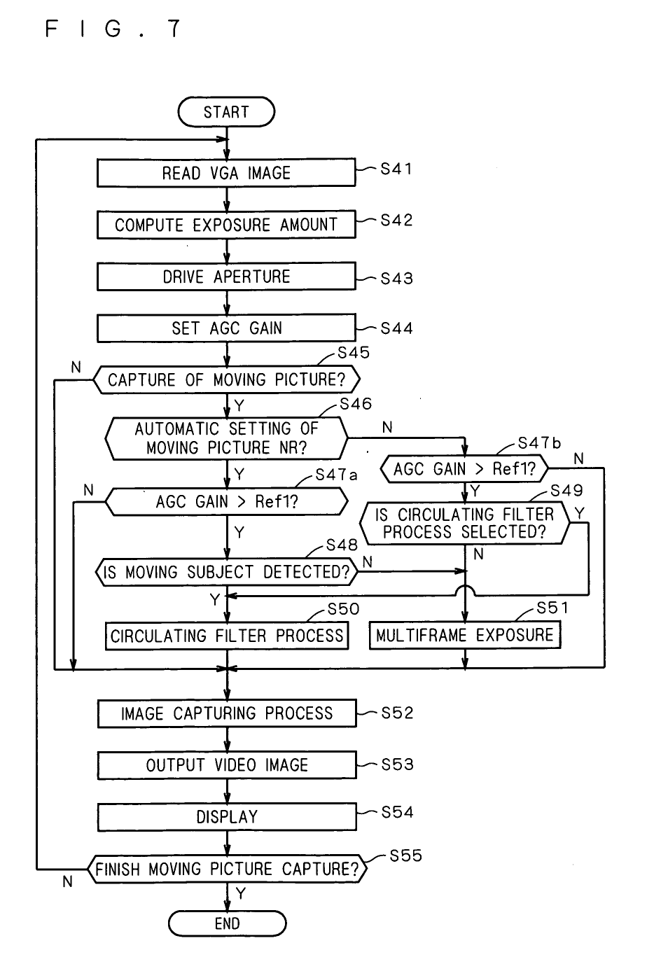

FIG. 7 is a flowchart showing a basic operation of the image capturing apparatus 1B. The operation is executed by the camera controller 40B.

In steps S41 to S47a and S47b, operations similar to those of steps S21 to S27a and S27b shown in the flowchart of FIG. 5 are performed.

In step S48, whether a moving subject is detected or not is determined. Concretely, whether movement of a main subject such as a human is detected or not is determined by the focus calculator/motion detector 36.

The detection of a moving subject is determined to select the circulating filter process which is adapted to movement of a subject in the case of a moving subject and to select the multiframe exposure in the case where a subject is not a moving subject, that is, a stationary subject. By the operation, noise due to a blur caused by movement of the subject at the time of moving picture capture can be reduced.

In the case where a moving subject is detected in step S48, the program advances to step S50. In the case where a moving subject is not detected, the program advances to step S51. In such a manner, either the circulating filter process or the multiframe exposure is selected according to the movement of the subject.

In steps S49 to S55, operations similar to those in steps S29 to S35 shown in the flowchart of FIG. 5 are performed.

As described above, the image capturing apparatus 1B selects either the circulating filter process or the multiframe exposure in accordance with detection of a moving subject. Thus, an optimum noise reducing process can be performed.

### Third Preferred Embodiment

An image capturing apparatus 1C according to a third preferred embodiment of the present invention has a configuration similar to that of the image capturing apparatus 1A of the first preferred embodiment except for the camera controller as shown in FIGS. 1 and 2.

Specifically, in a camera controller 40C of the image capturing apparatus 1C, a program for properly selecting two kinds of noise reducing processes in accordance with an image capturing mode is stored in a memory.

As the two kinds of noise reducing processes, the noise reducing processes of the circulating filter process and the multiframe exposure described in the first preferred embodiment can be selected. In the image capturing apparatus 1C, according to a setting state of the image capturing mode (sports mode, night view mode and macro mode), the two kinds of the noise processes can be switched.

As the image capturing mode, any of the image capturing modes of “sports mode”, “night view mode” and “macro mode” can be selected on a menu screen displayed on, for example, the LCD monitor 42 by an operation of the user on the frame-advance/zoom switch 15. The user can selectively designate a plurality of image capturing modes by the operation of the frame-advance/zoom switch 15.

Operation of Image Capturing Apparatus 1C

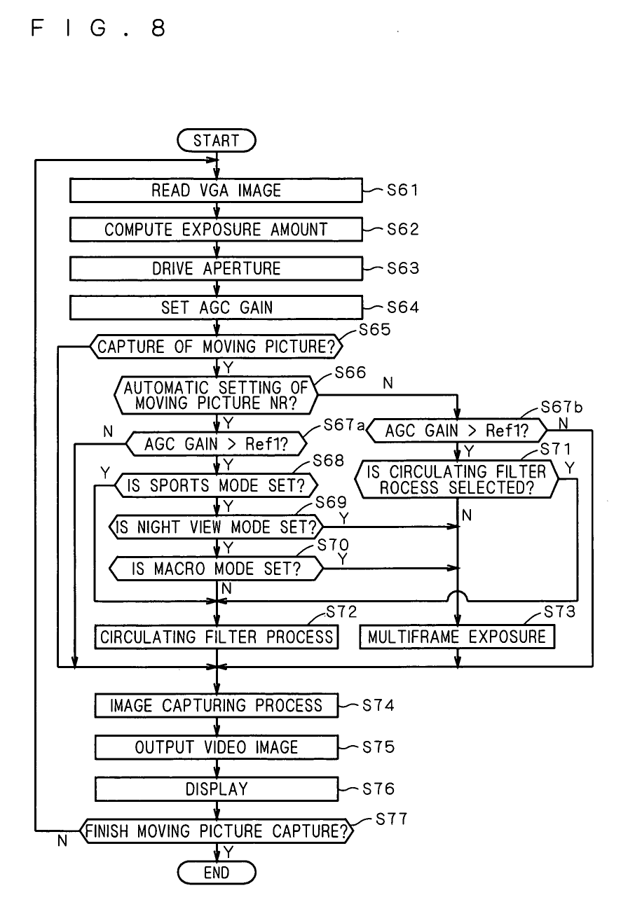

FIG. 8 is a flowchart showing a basic operation of the image capturing apparatus 1C. The operation is executed by the camera controller 40C.

In steps S61 to S67a and S67b, operations similar to those of steps S21 to S27a and S27b shown in the flowchart of FIG. 5 are performed.

In step S68, whether the sport mode is set or not is determined. Concretely, whether the “sports mode” is selected on the menu screen displayed on the LCD monitor 42 or not is determined.

The reason why the setting of the sports mode is determined is that when the sports mode is selected, priority is given to a high-speed shutter, so that noise is reduced by the circulating filter process without performing the multiframe exposure in which exposure time corresponds to a plurality of frames.

If the sports mode is set in step S68, the program advances to step S72. If the sports mode is not set, the program advances to step S69.

In step S69, whether the night view mode is set or not is determined. Concretely, whether the “night view mode” is selected on the menu screen displayed on the LCD monitor 42 or not is determined.

The reason why setting of the night view mode is determined is that when the night view mode in which a camera-shake often occurs is selected, generally, use of a tripod is assumed. Therefore, it is preferable to reduce noise by the multiframe exposure, not by the circulating filter process.

In the case where the night view mode is set in step S69, the program advances to step S73. In the case where the night view mode is not set, the program advances to step S70.

In step S70, whether the macro mode is set or not is determined. Concretely, whether the “macro mode” is selected on the menu screen displayed on the LCD monitor 42 or not is determined.

The reason why setting of the macro mode is determined is that, generally, use of a tripod is assumed when the macro mode in which a camera-shake often occurs is selected. In this case, it is preferable to remove noise by the multiframe exposure not by the circulating filter process.

In the case where the macro mode is set in step S70, the program advances to step S73. In the case where the macro mode is not set, the program advances to step S72.

By the operations in steps S68 to S70, either the circulating filter process or the multiframe exposure is selected in accordance with a designated image capturing mode.

In steps S71 to S77, operations similar to those in steps S29 to S35 shown in the flowchart of FIG. 5 are performed.

As described above, in the image capturing apparatus 1C, either the circulating filter process or the multiframe exposure is selected in accordance with the image capturing mode to be set, so that an optimum noise reducing process can be performed.

### Fourth Preferred Embodiment

An image capturing apparatus 1D according to a fourth preferred embodiment of the present invention has a configuration similar to that of the image capturing apparatus 1A of the first preferred embodiment as shown in FIGS. 1 and 2 except for the configuration of the circulating filter.

Specifically, in the circulating filter 26 of the image capturing apparatus 1D, in the correlation detector 261 shown in FIG. 3, a feedback factor is set on the basis of not only an AF evaluation value which is used in the first preferred embodiment but also a measurement value (detection value) of the camera-shake sensor 49.

The operation of the circulating filter process (NR1) of the image capturing apparatus 1D having the circulating filter 26 will be described below.

Circulating Filter Process (NR1)

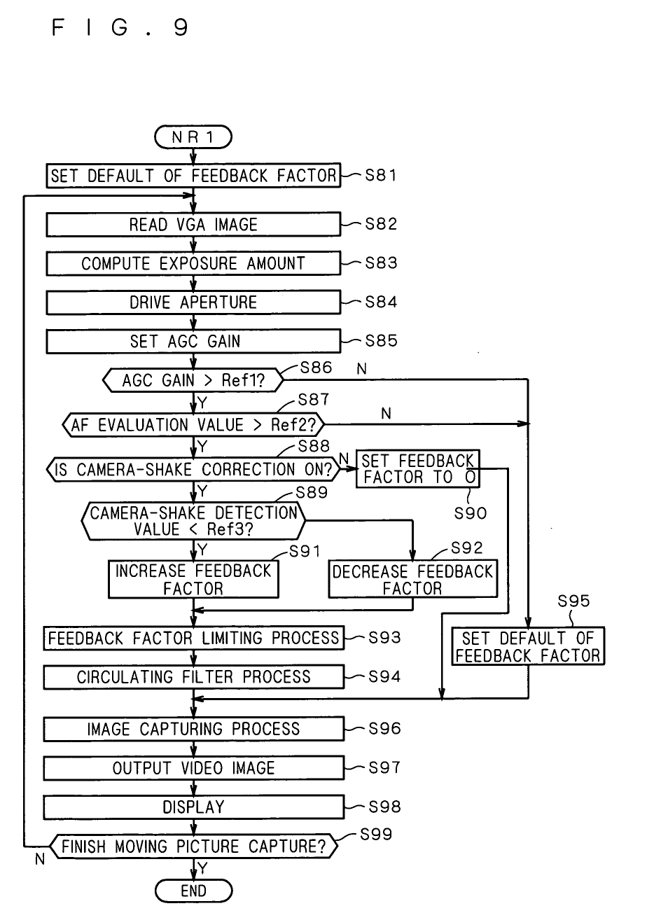

FIG. 9 is a flowchart showing the operation of the circulating filter process in the image capturing apparatus 1D. The operation is executed by a camera controller 40D.

In steps S81 to S87, operations similar to those in steps S1 to S7 shown in the flowchart of FIG. 4 are performed.

In step S88, whether camera-shake correction is “ON” or not is determined. Concretely, whether the camera-shake correction switch 14 is depressed to thereby set the camera-shake correction mode or not is determined. In the case where the camera-shake correction is “ON”, the program advances to step S89. In the case where the camera-shake correction is not “ON”, the program advances to step S90 and the feedback factor is set to 0.

In step S89, whether a detection value of a camera-shake detected by the camera-shake sensor 49 is smaller than a predetermined threshold Ref3 or not is determined. In this case, an AF evaluation value exceeds the predetermined value Ref2 in step S87, so that it can be estimated that a subject is stationary to a certain extent. Therefore, in the case where the camera-shake detection value is smaller than a reference value Ref3, it can be determined that frame correlation is high, so that the feedback factor is increased in step S91. On the other hand, when the camera-shake detection value is equal to or more than the predetermined value Ref3, an error occurs in a feedback process due to a camera-shake, so that the feedback factor is decreased in step S92.

In steps S91 to S99, operations similar to those in steps S9 to S17 shown in the flowchart of FIG. 4 are performed.

In the moving picture capture at the time of low illuminance, by making the circulating filter process and the multiframe exposure selectable, effects similar to those of the first to third preferred embodiments can be exhibited.

### Fifth Preferred Embodiment

An image capturing apparatus 1E according to a fifth preferred embodiment of the present invention has a configuration similar to that of the image capturing apparatus 1A of the first preferred embodiment except for the configuration of the circulating filter as shown in FIGS. 1 and 2.

In the circulating filter 26 of the image capturing apparatus 1E, a feedback factor according to the focal length of the taking lens 10 is set in the correlation detector 261 shown in FIG. 3.

Since an occurrence level of a camera-shake varies according to the focal length (angle of view) of the taking lens 10, in the case of long focal length, it is assumed that small blurs occur in an image of the subject due to a camera-shake. When the feedback factor is increased in the case where the correlation between neighboring frames becomes low due to the camera-shake, degradation occurs in the image. Consequently, as will be described later, in the image capturing apparatus 1E, the feedback factor is set according to the focal length at the time of photographing. For example, the feedback factor of the feedback amplifier 264 is set to 0.8, 0.5 and 0.2 under the condition that the focal length is less than 30 mm, in a range from 30 to 50 mm and in a range from 50 to 100 nm in 135 mm conversion, respectively, and the circulating filter process is performed. In such a manner, a proper feedback factor can be easily determined.

The operation of the circulating filter process (NR1) of the image capturing apparatus 1E having such a circulating filter 26 will be described below.

Circulating Filter Process (NR1)

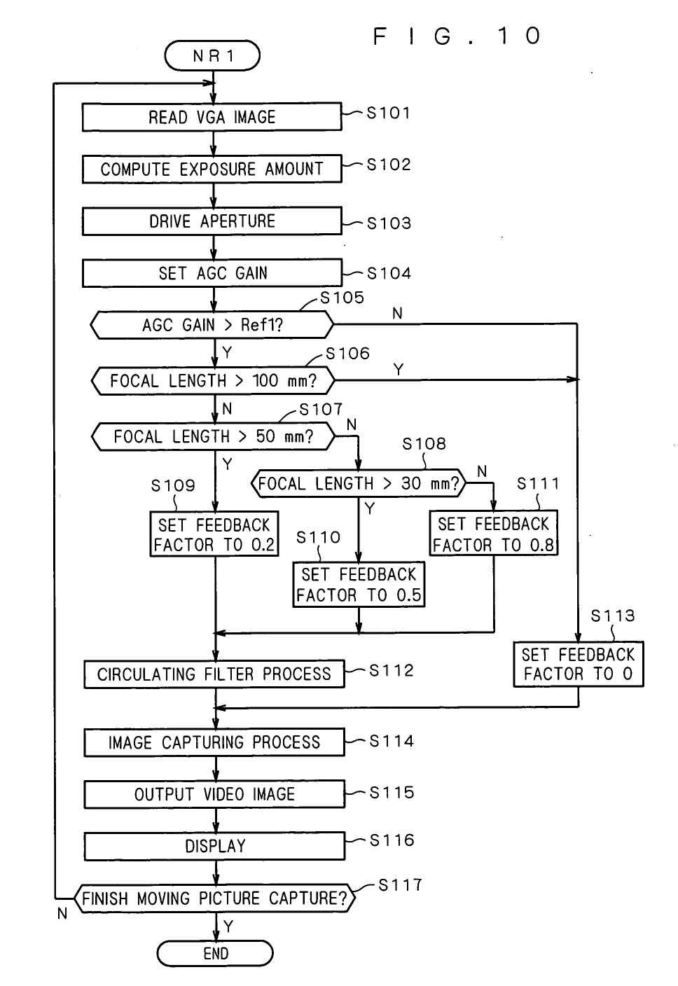

FIG. 10 is a flowchart showing the operation of the circulating filter process in the image capturing apparatus 1E. The operation is executed by a camera controller 40E.

In steps S101 to S105, operations similar to those in steps S2 to S6 shown in the flowchart of FIG. 4 are performed.

In step S106, whether the focal length of the taking lens 10 is longer than 100 mm or not is determined. In the case where the focal length is longer than 100 mm, the program advances to step S113. In the case where the focal length is equal to or less than 100 mm, the program advances to step S107.

In step S107, whether the focal length of the taking lens 10 is longer than 50 mm or not is determined. In the case where the focal length is longer than 50 mm, the program advances to step S109. In the case where the focal length is equal to or less than 50 mm, the program advances to step S108.

In step S108, whether the focal length of the taking lens 10 is longer than 30 mm or not is determined. In the case where the focal length is longer than 30 mm, the program advances to step S110. In the case where the focal length is equal to or less than 30 mm, the program advances to step S111.

In step S109, the feedback factor of the feedback amplifier 264 is set to 0.2.

In step S110, the feedback factor of the feedback amplifier 264 is set to 0.5.

In step S111, the feedback factor of the feedback amplifier 264 is set to 0.8.

In step S112, an operation similar to that in step S12 shown in the flowchart of FIG. 4 is performed.

In step S113, the feedback factor of the feedback amplifier 264 is set to 0. That is, the circulating filter process is inhibited.

In steps S114 to S117, operations similar to those in steps S14 to S17 shown in the flowchart of FIG. 4 are performed.

By making the circulating filter process and the multiframe exposure selectable in the moving picture capture at the time of low illuminance, effects similar to those in the first to third preferred embodiments can be exhibited.

### Sixth Preferred Embodiment

An image capturing apparatus 1F according to a sixth preferred embodiment of the present invention has, as shown in FIGS. 1 and 2, a configuration similar to that of the image capturing apparatus 1A of the first preferred embodiment except for the configuration of the circulating filter.

In the circulating filter 26 of the image capturing apparatus 1F, in the correlation detector 261 shown in FIG. 3, a feedback factor according to the shutter speed is set.

In the case where an AF evaluation value exceeds a predetermined value, it can be determined that a subject is stationary to a certain extent. In this case, a feedback factor control is performed in link with a calculated computation value (set value) of SS (shutter speed). For example, it is assumed that a proper circulating filter process is executed by setting the feedback factor of the feedback amplifier 264 to 0.2, 0.5 and 0.8 under the conditions that SS is less than 1/250 sec, in a range from 1/250 to 1/100 sec and in a range from 1/100 to 1/30 sec, respectively. When SS is short time, that is, at the time of high speed shutter, correlation between frame images is low. Consequently, when the feedback factor is increased, an after-image effect is produced, and an unnatural image is generated by the circulating filter process. Therefore, the shorter the SS is, a smaller feedback factor is set. On the other hand, with respect to SS (exposure time) of 1/30 s or longer, priority is given to multiframe image capture, and the circulating filter process is inhibited because the possibility that a camera-shake is induced is high.

The operation of the circulating filter process (NR1) of the image capturing apparatus 1F having the circulating filter 26 will be described below.

Circulating Filter Process (NR1)

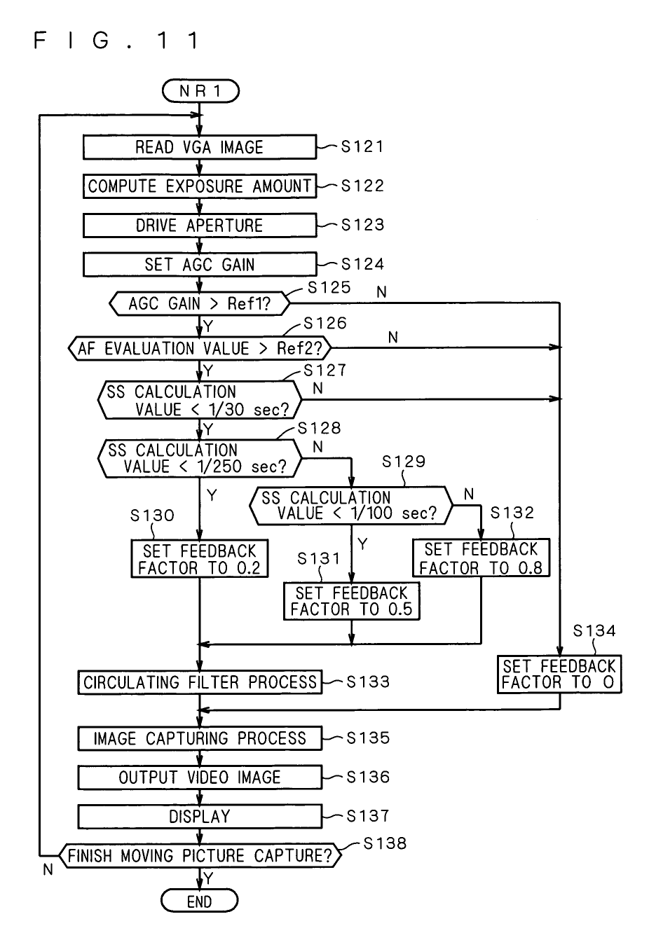

FIG. 11 is a flowchart showing the operation of a circulating filter process in the image capturing apparatus 1F. The operation is executed by a camera controller 40F.

In steps S121 to S126, operations similar to those in steps S2 to S7 shown in the flowchart of FIG. 4 are performed.

In step S127, whether a computation value of SS (Shutter Speed) is shorter than 1/30 sec or not is determined. In the case where it is shorter than 1/30 sec, the program advances to step S128. In the case where it is equal to or more than 1/30 sec, the program advances to step S134.

In step S128, whether a computation value of SS is shorter than 1/250 sec or not is determined. In the case where it is shorter than 1/250 sec, the program advances to step S130. In the case where it is equal to or more than 1/250 sec, the program advances to step S129.

In step S129, whether the computation value of SS is shorter than 1/100 sec or not is determined. In the case where it is shorter than 1/100 sec, the program advances to step S131. In the case where it is equal to or more than 1/100 sec, the program advances to step S132.

In step S130, the feedback factor of the feedback amplifier 264 is set to 0.2.

In step S131, the feedback factor of the feedback amplifier 264 is set to 0.5.

In step S132, the feedback factor of the feedback amplifier 264 is set to 0.8.

In step S133, an operation similar to that in step S12 shown in the flowchart of FIG. 4 is performed.

In step S134, the feedback factor of the feedback amplifier 264 is set to 0. Specifically, when the set value of SS becomes equal to or more than 1/30 sec, priority is given to the multiframe exposure, and the circulating filter process is inhibited.

In steps S135 to S138, operations similar to those in steps S14 to S17 shown in the flowchart of FIG. 4 are performed.

By making the circulating filter process and the multiframe exposure selectable in the moving picture capture at the time of low illuminance, effects similar to those of the first to third preferred embodiments can be exhibited.

Modification

In each of the foregoing preferred embodiments, in the case of the low-illuminance image capturing condition in which the set gain of the AGC is equal to or more than the predetermined value (Ref1), it is not indispensable to make the circulating filter process and the multiframe exposure selectable. It is also possible to select both of the noise processes when the low-illuminance image capturing condition that the subject illuminance is equal to or less than a predetermined value is satisfied.

While the invention has been shown and described in detail, the foregoing description is in all aspects illustrative and not restrictive. It is therefore understood that numerous modifications and variations can be devised without departing from the scope of the invention.

1. An image capturing apparatus comprising:
an image generator for capturing an image of a subject and sequentially generating frame images of said subject;
a first noise reducer for performing a first noise process using a feedback factor on said frame images sequentially generated by said image generator;
a second noise reducer for performing a second noise process by lowering frame rate at the time of generating said frame images by said image generator; and
a selector for selecting either said first noise reducer or said second noise reducer when a predetermined image capturing condition is satisfied.

2. The image capturing apparatus according to claim 1, wherein
said first noise reducer is a circulating filter for performing the first noise process by multiplying a difference image between a present frame image and an image of an immediately preceding frame with a feedback factor and subtracting a resultant image from said present frame image.

3. The image capturing apparatus according to claim 2, wherein
said feedback factor is determined in accordance with correlation between said present frame image and said image of said immediately preceding frame.

4. The image capturing apparatus according to claim 1, further comprising:
a manual operation member to be operated by a user, wherein
said selector selects either said first noise reducer or said second noise reducer in accordance with an operation input of said manual operation member.

5. The image capturing apparatus according to claim 1, further comprising:
a detector for detecting motion of said subject, wherein
said selector selects either said first noise reducer or said second noise reducer on the basis of a detection result of said detector.

6. The image capturing apparatus according to claim 5, wherein
said selector selects said first noise reducer when it is detected by said detector that said subject is a moving subject.

7. The image capturing apparatus according to claim 1, further comprising:
a taking lens of which focal length can be varied, wherein
said selector selects either said first noise reducer or said second noise reducer in accordance with said focal length of said taking lens.

8. The image capturing apparatus according to claim 7, wherein
said selector selects said first noise reducer when said focal length of said taking lens is equal to or more than a predetermined value.

9. The image capturing apparatus according to claim 1, further comprising:
a connection part to which a tripod is to be connected; and
a tripod detector for detecting whether said tripod is connected to said connection part or not, wherein
said selector selects either said first noise reducer or said second noise reducer on the basis of a detection result of said tripod detector.

10. The image capturing apparatus according to claim 9, wherein
said selector selects said second noise reducer when said tripod is connected to said connection part.

11. The image capturing apparatus according to claim 1, wherein
a plurality of image capturing modes can be selectively designated and
said selector selects either said first noise reducer or said second noise reducer in accordance with a designated image capturing mode.

12. The image capturing apparatus according to claim 11, wherein
said selector selects said first noise reducer when an image capturing mode in which priority is given to high shutter speed is designated, and selects said second noise reducer when an image capturing mode for night view capturing or an image capturing mode for macro image capturing is designated.

13. The image capturing apparatus according to claim 1, further comprising:
an amplifier for amplifying a frame image generated by said image generator with a predetermined gain, wherein
said predetermined image capturing condition is that a gain of said amplifier is equal to or more than a predetermined value.

14. The image capturing apparatus according to claim 1, wherein
said predetermined image capturing condition is that luminance of said subject is equal to or less than a predetermined value.

15. The image capturing apparatus according to claim 1, wherein
said feedback factor is changed in accordance with an image capturing condition.

16. The image capturing apparatus according to claim 1, wherein
a still picture can be captured and
at the time of performing said still picture capturing, a noise process by neither said first noise reducer nor said second noise reducer is performed.

17. A method of performing a noise process on a moving picture, comprising the steps of:
(a) capturing an image of a subject and sequentially generating frame images of said subject;
(b) selecting a first noise process using a feedback factor on said frame images sequentially generated in said step (a) or a second noise process performed by reducing frame rate at the time of generating said frame images, when a predetermined image capturing condition is satisfied; and
(c) performing a noise process selected in said step (b).

18. The method of performing a noise process on a moving picture according to claim 17, wherein
said predetermined image capturing condition is that illuminance is low.
